(19) United States
(12) Patent Application Publication
(10) Pub. No.: US 2026/0243059 A1
(43) Pub. Date: Aug. 20, 2026

(54) WORK MACHINE AND CONTROL METHOD FOR WORK MACHINE

(71) Applicant: KOMATSU LTD., Tokyo (JP)

(72) Inventors: Takeshi YOSHIDA, Tokyo (JP); Takuya FUJIKAWA, Tokyo (JP)

(73) Assignee: KOMATSU LTD., Tokyo (JP)

(21) Appl. No.: 19/161,267

(22) PCT Filed: Feb. 27, 2024
(86) PCT No.: PCT/JP2024/007082

§ 371 Date: Aug. 31, 2025

(30) Foreign Application Priority Data
Mar. 29, 2023 (JP) 2023-053859

(51) Int. Cl. E02F 9/20; B60L 50/53; B60L 58/15

(52) U.S. Cl. CPC E02F 9/2091; B60L 50/53; B60L 58/15; B60L 2200/40

(57) ABSTRACT

A work machine includes a power supply device connected to an external power supply, a battery charged by the power supply device, an electric motor configured to be driven based on at least one of electric power supplied from the external power supply and electric power supplied from the battery, and a controller configured to vary the electric power supplied from the external power supply to the electric motor to follow electric power usage of the electric motor.

### TECHNICAL FIELD

The present disclosure relates to a work machine and a control method for a work machine.

### BACKGROUND ART

A work machine that operates using electric power supplied from a battery is known. When the work machine is operated only by the electric power supplied from the battery, there is a possibility that the operating time of the work machine is insufficient. When a large-capacity battery is mounted on the work machine in order to suppress the shortage of the operating time, the battery may occupy most of the space of the work machine, and the work machine may be increased in size. In addition, when a large-capacity battery is mounted on a work machine, the cost of the work machine may increase. By operating the work machine using both the electric power supplied from the external power supply and the electric power supplied from the battery, it is possible to extend the operating time and reduce the capacity of the battery. Patent Document 1 discloses a construction machine that uses both electric power supplied from an external power supply and electric power supplied from a battery.

### CITATION LIST

### Patent Literature

Patent Document 1: JP 2022-109029 A

### SUMMARY OF INVENTION

### Technical Problem

By operating the work machine with the electric power supplied from the external power supply, the charge/discharge amount of the battery is reduced, and thus there is a possibility that a decrease in the life of the battery is suppressed. On the other hand, when a battery having a small capacity is mounted on the work machine in order to reduce the space occupied by the battery, the ratio of the charge/discharge amount to the capacity of the battery increases, and thus the life of the battery may be reduced.

An object of the present disclosure is to suppress a decrease in the life of a battery in a work machine that uses both an external power supply and the battery.

### Solution to Problem

According to the present disclosure, there is provided a work machine including a power supply unit connected to an external power supply, a battery charged by the power supply unit, an electric motor configured to be driven based on at least one of electric power supplied from the external power supply and electric power supplied from the battery, and a controller configured to vary the electric power supplied from the external power supply to the electric motor to follow electric power usage of the electric motor.

### Advantageous Effects of Invention

According to the present disclosure, in a work machine using both an external power supply and a battery, it is possible to suppress a decrease in the life of the battery.

### BRIEF DESCRIPTION OF DRAWINGS

FIG. 1 is a diagram schematically illustrating a work machine according to an embodiment.

FIG. 2 is a block diagram illustrating the work machine according to the embodiment.

FIG. 3 is a block diagram illustrating a controller according to the embodiment.

FIG. 4 is a diagram for describing an operation method for the work machine according to the embodiment.

FIG. 5 is a diagram for describing the operation method for the work machine according to the embodiment.

FIG. 6 is a block diagram illustrating a controller according to the embodiment.

FIG. 7 is a flowchart illustrating a control method for the work machine according to the embodiment.

FIG. 8 is a diagram illustrating power output from a power supply unit and power output from a battery with respect to electric power usage of a load according to a comparative example.

FIG. 9 is a diagram illustrating power output from a power supply unit and power output from a battery with respect to electric power usage of a load according to the embodiment.

### DESCRIPTION OF EMBODIMENTS

Hereinafter, embodiments of the present disclosure will be described, but the present disclosure is not limited to the embodiments. Components of the embodiments described below can be combined as appropriate. Some components are not used in some cases.

### Work Machine

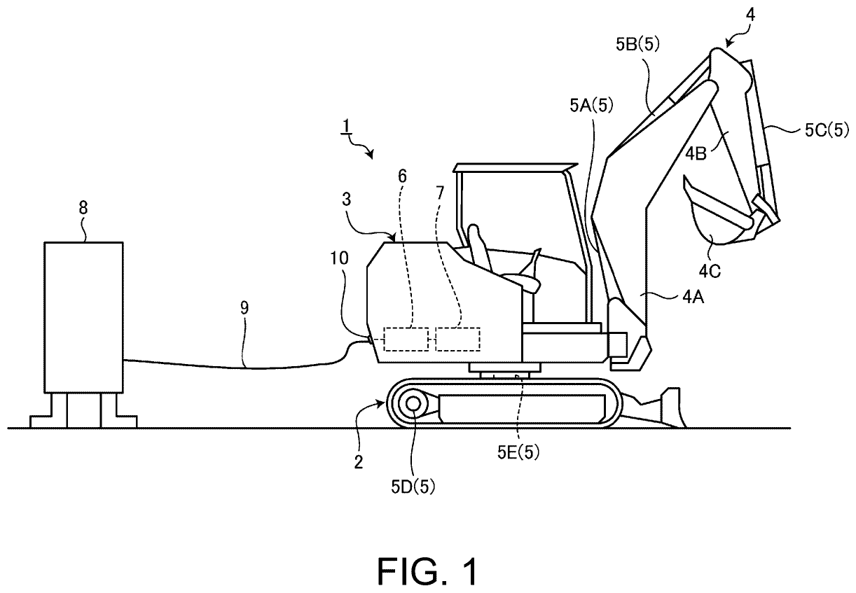

FIG. 1 is a diagram schematically illustrating a work machine 1 according to an embodiment. In the embodiment, the work machine 1 is an electric work machine that is driven by an external power supply and a battery. In the embodiment, the work machine 1 is an electric shovel. The work machine 1 includes a lower traveling body 2, an upper revolving body 3, a work implement 4, a hydraulic actuator 5, a power supply unit 6, and a battery 7.

The lower traveling body 2 includes a pair of the continuous tracks. The lower traveling body 2 is capable of traveling on the ground. The upper revolving body 3 is supported by the lower traveling body 2. The upper revolving body 3 is capable of revolving. The work implement 4 is supported by the upper revolving body 3. The work implement 4 includes a boom 4A connected to the upper revolving body 3, an arm 4B connected to the boom 4A, and a bucket 4C connected to the arm 4B. The hydraulic actuator 5 includes a boom cylinder 5A that operates the boom 4A, an arm cylinder 5B that operates the arm 4B, and a bucket cylinder 5C that operates the bucket 4C. Each of the boom cylinder 5A, the arm cylinder 5B, and the bucket cylinder 5C is a hydraulic cylinder. The hydraulic actuator 5 also includes a traveling motor 5D that rotates the continuous track of the lower traveling body 2 and a revolving motor 5E that revolves the upper revolving body 3. Each of the traveling motor 5D and the revolving motor 5E is a hydraulic motor.

The power supply unit 6 is connected to an external power supply 8. The external power supply 8 is a commercial power supply. The power supply unit 6 is disposed on the upper revolving body 3. The external power supply 8 is connected to the work machine 1 via a cable 9. A power supply port 10 is provided on the upper revolving body 3. The cable 9 is attached to and detached from the power supply port 10. The power supply unit 6 is fed from an external power supply 8 via a cable 9 and a power supply port 10.

The battery 7 is an internal battery mounted on the upper revolving body 3. The battery 7 includes a secondary battery. In the embodiment, the battery 7 includes a rechargeable lithium-ion battery. The battery 7 is charged by the power output from the power supply unit 6.

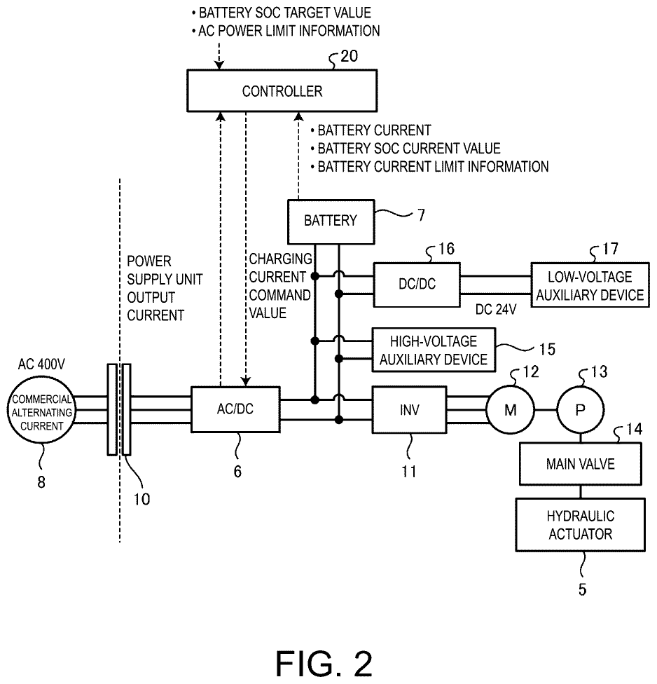

FIG. 2 is a block diagram illustrating the work machine 1 according to the embodiment. The work machine 1 includes the power supply port 10, the power supply unit 6, the battery 7, an inverter 11, an electric motor 12, a hydraulic pump 13, a main valve 14, a hydraulic actuator 5, a high-voltage auxiliary device 15, a DC/DC converter 16, a low-voltage auxiliary device 17, and a controller 20.

The power supply unit 6 is connected to an external power supply 8 via a power supply port 10. The power supply unit 6 converts an AC voltage supplied from the external power supply 8 into a DC voltage. The power supply unit 6 is configured to supply electric power to at least one of the battery 7, the inverter 11, the high-voltage auxiliary device 15, and the DC/DC converter 16.

The battery 7 can be charged by electric power supplied from the power supply unit 6. The battery 7 is configured to supply electric power to at least one of the inverter 11, the high-voltage auxiliary device 15, and the DC/DC converter 16.

The inverter 11 is supplied with power from each of the power supply unit 6 and the battery 7. The inverter 11 converts a DC voltage input from at least one of the power supply unit 6 and the battery 7 into an AC voltage. The AC voltage converted by the inverter 11 is input to the electric motor 12.

The electric motor 12 is driven based on at least one of the electric power supplied from the external power supply 8 via the power supply unit 6 and the electric power supplied from the battery 7. The electric motor 12 is driven by AC power supplied from the inverter 11. The electric motor 12 is driven by using at least one of the electric power output from the power supply unit 6 and the electric power output from the battery 7.

The hydraulic pump 13 is driven by the electric motor 12. The hydraulic pump 13 discharges hydraulic oil. The hydraulic oil discharged from the hydraulic pump 13 is supplied to the hydraulic actuator 5 via a main valve 14.

Each of the high-voltage auxiliary device 15 and the low-voltage auxiliary device 17 is a load (electric device) different from the electric motor 12. The high-voltage auxiliary device 15 is connected in parallel with the inverter 11. The low-voltage auxiliary device 17 is connected in parallel with the inverter 11. The high-voltage auxiliary device 15 is driven at a higher voltage than the low-voltage auxiliary device 17. The high-voltage auxiliary device 15 is driven by at least one of the electric power supplied from the external power supply 8 via the power supply unit 6 and the electric power supplied from the battery 7. The high-voltage auxiliary device 15 is driven by using at least one of the electric power output from the power supply unit 6 and the electric power output from the battery 7. The low-voltage auxiliary device 17 is driven based on at least one of the electric power supplied from the external power supply 8 via the power supply unit 6 and the electric power supplied from the battery 7. The low-voltage auxiliary device 17 is driven by using at least one of the electric power output from the power supply unit 6 and the electric power output from the battery 7.

The DC/DC converter 16 converts a voltage input from at least one of the power supply unit 6 and the battery 7 into a predetermined voltage. In the embodiment, the DC/DC converter 16 steps down the input voltage at a predetermined step-down ratio. The DC/DC converter 16 is connected in parallel to the inverter 11. The low-voltage auxiliary device 17 is driven based on the power output from the DC/DC converter 16.

### Controller

The controller 20 controls the work machine 1. The controller 20 drives the electric motor 12 by using both the electric power supplied from the external power supply 8 via the power supply unit 6 and the electric power supplied from the battery 7.

The controller 20 varies the electric power supplied from the external power supply 8 to the electric motor 12 via the power supply unit 6 to follow the electric power usage of the electric motor 12. The controller 20 outputs a control command to the power supply unit 6 so that the electric power supplied from the external power supply 8 to the electric motor 12 increases as the electric power usage of the electric motor 12 increases. The controller 20 outputs a control command to the power supply unit 6 so that the electric power supplied from the external power supply 8 to the electric motor 12 decreases as the electric power usage of the electric motor 12 decreases.

In the embodiment, the controller 20 outputs a control command to the power supply unit 6 so that the electric power supplied from the external power supply 8 to the electric motor 12 via the power supply unit 6 varies based on the electric power output from the power supply unit 6 and the electric power output from the battery 7.

In the embodiment, the power output from the power supply unit 6 includes a power supply unit output current indicating an output current from the power supply unit 6. The electric power output from the battery 7 includes a battery current indicating an output current from the battery 7. The power supply unit output current is input to the controller 20. For example, when a first current sensor that detects the power supply unit output current is provided, the detection data of the first current sensor is input to the controller 20. The battery current is input to the controller 20. For example, when a second current sensor that detects the current of the battery 7 is provided, the detection data of the second current sensor is input to the controller 20. The controller 20 outputs a control command to the power supply unit 6 based on the power supply unit output current and the battery current so that the load current supplied from the external power supply 8 to the electric motor 12 via the power supply unit 6 varies.

The electric power output from the power supply unit 6 to the inverter 11 and the electric power output from the battery 7 to the inverter 11 vary based on the total electric power usage indicating the total of the electric power usage of each of the plurality of loads (electric devices) including the electric motor 12, the high-voltage auxiliary device 15, and the low-voltage auxiliary device 17. The controller 20 can vary the electric power output from the power supply unit 6 to the inverter 11 to follow the total electric power usage of the plurality of loads including the electric motor 12, the high-voltage auxiliary device 15, and the low-voltage auxiliary device 17.

Further, a battery SOC current value indicating the current charging rate (state of charge: SOC) of the battery 7 and a battery SOC target value indicating a target value of the charging rate of the battery 7 are input to the controller 20. The charging rate of the battery 7 refers to a ratio of a charging amount to a capacity (full charge capacity) of the battery 7. The battery SOC current value is calculated based on, for example, detection data of a voltage sensor that detects the output voltage of the battery 7. The battery SOC target value is a predetermined value, and may be input from a predetermined input device or may be stored in a storage mounted on the work machine 1.

Further, AC power limit information indicating an upper limit value of the power supply unit output current and battery current limit information indicating an upper limit value of the battery current are input to the controller 20. The upper limit value of the power supply unit output current and the upper limit value of the battery current are predetermined values. There is an upper limit to the amount of electric power that can be output by the external power supply 8. The AC power limit information indicates an upper limit value of the amount of electric power (power supply unit output current) that can be output by the external power supply 8. The amount of electric power that can be output by the external power supply 8 is preferably 80% or more of the total amount of electric power usage of the loads (load current). Similarly, there is an upper limit to the amount of electric power that can be output by the battery 7. The battery current limit information indicates an upper limit value of the amount of electric power (battery current) that can be output by the battery 7.

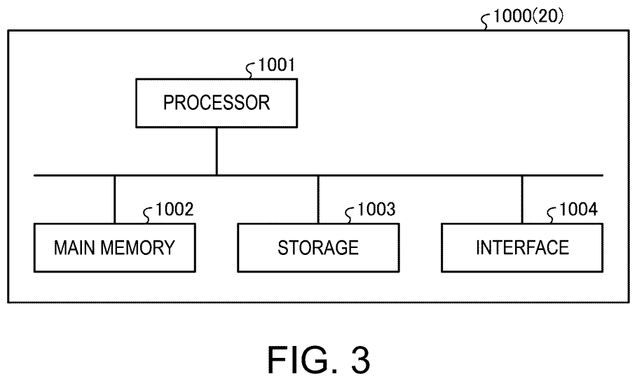

FIG. 3 is a block diagram illustrating the controller 20 according to the embodiment. The controller 20 includes a computer system 1000. The computer system 1000 includes a processor 1001 such as a central processing unit (CPU), a main memory 1002 including a non-volatile memory such as a read only memory (ROM) and a volatile memory such as a random access memory (RAM), a storage 1003, and an interface 1004 including an input/output circuit. Functions of the controller 20 are stored in the storage 1003 as a computer program. The processor 1001 reads out the computer program from the storage 1003, deploys the computer program into the main memory 1002, and executes the above-described process in accordance with the program. Note that the computer program may be distributed to the computer system 1000 via a network.

### Operation Method

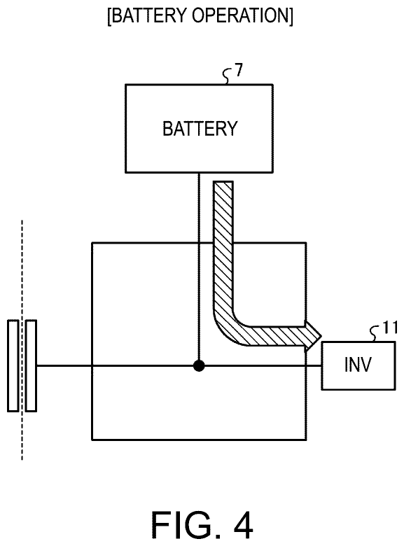

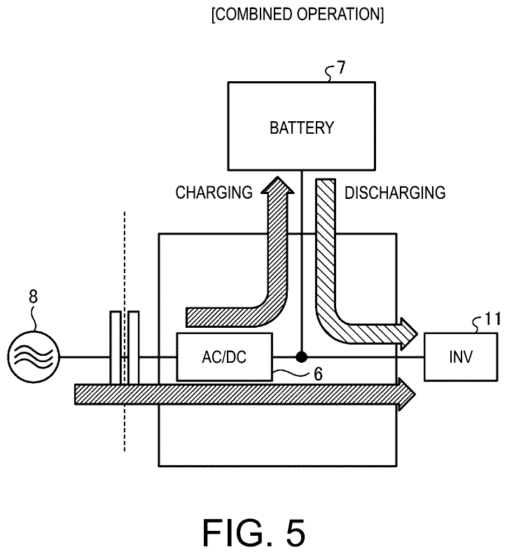

Each of FIGS. 4 and 5 is a diagram for describing operation method for the work machine 1 according to the embodiment. As illustrated in FIG. 4, the work machine 1 can operate in a battery operation method in which the work machine 1 operates using only the electric power output from the battery 7. As illustrated in FIG. 5, the work machine 1 can operate in a combined operation method in which the work machine 1 operates using both the electric power output from the external power supply 8 and the electric power output from the battery 7.

In the combined operation method, the controller 20 controls the power supply unit 6 to follow the amount of electric power usage of the electric motor 12, thereby varying the amount of electric power supplied from the external power supply 8 to the electric motor 12 via the power supply unit 6 and the inverter 11. The amount of electric power supplied from the external power supply 8 to the electric motor 12 varies to follow the amount of electric power usage of the electric motor 12, thereby suppressing variation in the charge/discharge amount of the battery 7. By suppressing the variation in the charge/discharge amount of the battery 7, the decrease in the life of the battery 7 is suppressed. Even if the capacity of the battery 7 is small, the ratio of the charge/discharge amount to the capacity of the battery 7 is reduced by suppressing the variation in the charge/discharge amount of the battery 7, and thus the decrease in the life of the battery 7 is suppressed.

As illustrated in FIG. 5, in the combined operation method, the power output from the power supply unit 6 is distributed to the battery 7 and the inverter 11. The battery 7 is charged with the electric power distributed to the battery 7. The electric motor 12 is driven by the electric power distributed to the inverter 11. When the battery 7 is charged during the operation of the work machine 1, the controller 20 outputs a control command to the power supply unit 6 so that the charging rate of the battery 7 does not exceed a specified value smaller than 100%. The state in which the work machine 1 is in operation means that the electric motor 12 is being driven. The specified value is a predetermined value and corresponds to the above-described battery SOC target value.

That is, when the battery 7 is charged during the operation of the work machine 1, the controller 20 controls the charging operation of the battery 7 by the power supply unit 6 so that the battery 7 is not fully charged. When the battery 7 is charged, the charging rate of the battery 7 is suppressed to a low value, and thus a decrease in the life of the battery 7 is suppressed.

While the work machine 1 is at rest, no power is supplied from the power supply unit 6 to the inverter 11, and no power is discharged from the battery 7. The work machine 1 being at rest means that the electric motor 12 is stopped. When the battery 7 is charged while the work machine 1 is stopped, the controller 20 may output a control command to the power supply unit 6 so that the charging rate of the battery 7 becomes 100%.

That is, when the battery 7 is charged while the work machine 1 is stopped, the controller 20 may control the charging operation of the battery 7 by the power supply unit 6 so that the battery 7 is fully charged. By fully charging the battery, the operating time when the battery is operated in the battery operation method can be extended compared to when the battery is not fully charged.

### Control Method

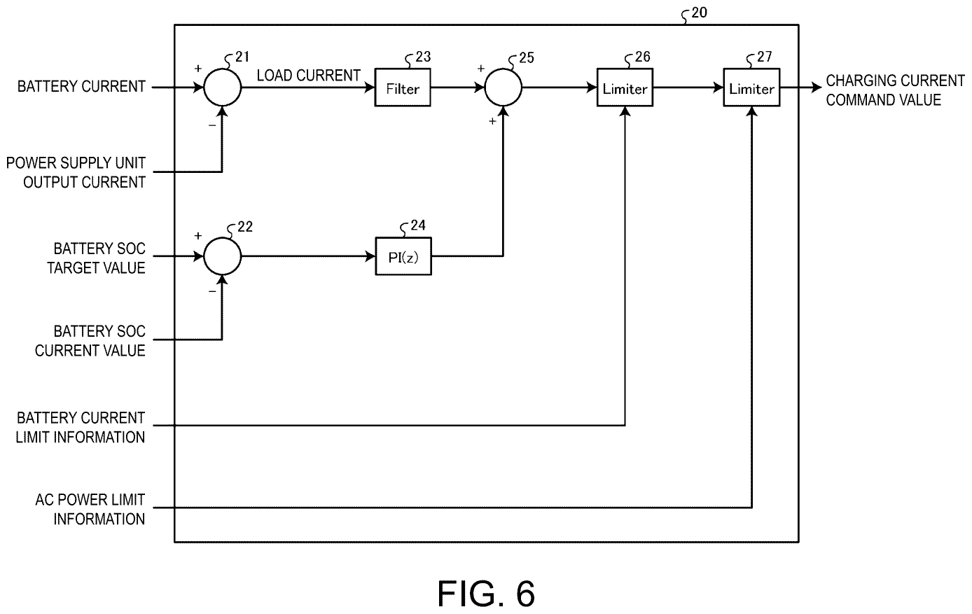

FIG. 6 is a block diagram illustrating the controller 20 according to the embodiment. The controller 20 includes a first calculation unit 21, a second calculation unit 22, a third calculation unit 23, a fourth calculation unit 24, a fifth calculation unit 25, a sixth calculation unit 26, and a seventh calculation unit 27. In an embodiment, the battery current, the power supply unit output current, the battery SOC target value, the battery SOC current value, the battery current limit information, and the AC power limit information are input to the controller 20.

The first calculation unit 21 calculates a load current indicating a current used by the load based on a difference between the battery current and the power supply unit output current. The second calculation unit 22 calculates a difference between the battery SOC target value and the battery SOC current value. The battery SOC target value is a value lower than 100%. The battery SOC target value may be, for example, 90%.

The third calculation unit 23 performs low-pass filter processing on the load current. The fourth calculation unit 24 calculates a charging current for charging the battery 7 based on a difference between the battery SOC target value and the battery SOC current value.

The fifth calculation unit 25 calculates a combined current of the load current output from the third calculation unit 23 and the charging current output from the fourth calculation unit 24.

The sixth calculation unit 26 receives the combined current from the fifth calculation unit 25 and the battery current limit information. The sixth calculation unit 26 outputs the smaller current value of the combined current and the upper limit value of the battery current.

The current value and the AC power limit information output from the sixth calculation unit 26 are input to the seventh calculation unit 27. The seventh calculation unit 27 outputs a control command to the power supply unit 6 so that the power supply unit output current follows the load current based on the smaller current value of the current value output from the sixth calculation unit 26 and the upper limit value of the power supply unit output current. The control command output to the power supply unit 6 includes a charging current command value for charging the battery 7 and a load current command value for driving a load.

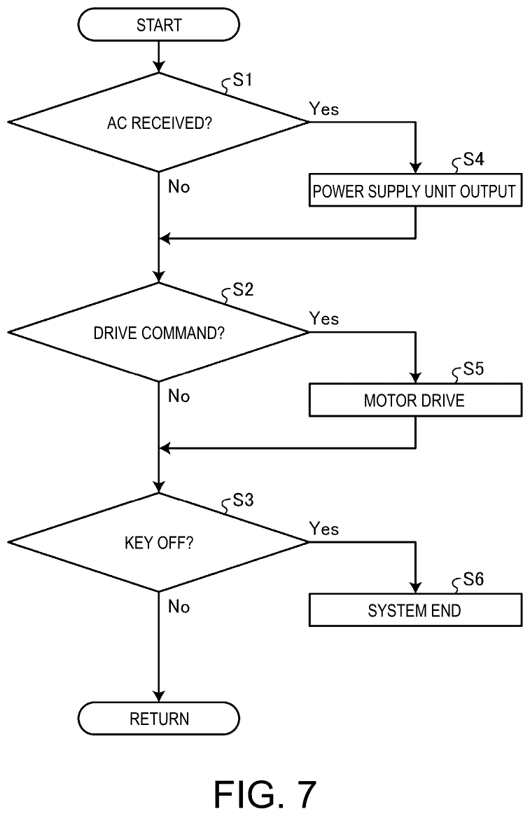

FIG. 7 is a flowchart illustrating a control method for the work machine 1 according to the embodiment. The controller 20 determines whether or not power is being supplied from the external power supply 8 via the power supply port 10 (step S1).

In step S1, when it is determined that power is supplied from the external power supply 8 (step S1: Yes), the controller 20 controls the power supply unit 6 so that power is output from the power supply unit 6 (step S4).

When it is determined in step S1 that no electric power is supplied from the external power supply 8 (step S1: No), or when electric power is output from the power supply unit 6 in step S4, the controller 20 determines whether to output a drive command for driving the electric motor 12 (step S2).

In step S2, when the drive command is output (step S2: Yes), the controller 20 drives the electric motor 12 (step S5).

When it is determined in step S2 that the drive command is not to be output (step S2: No), or when the electric motor 12 is driven in step S5, the controller 20 determines whether or not the vehicle is in the key-off state (step S3).

When it is determined in step S3 that the key-off state is set (step S3: Yes), the controller 20 ends the system (step S6).

In step S3, when it is determined that the key is not in the off state (step S3: No), the controller 20 returns to the process of step S1.

### Effects

As described above, in the work machine 1 using both the external power supply 8 and the battery 7, the controller 20 varies the electric power supplied from the external power supply 8 to the electric motor 12 to follow the electric power usage of the electric motor 12. This reduces the charge/discharge amount of the battery 7 (the ratio of the charge/discharge amount to the capacity of the battery 7). In addition, an increase in the number of cycles in which the battery 7 repeats charging and discharging is suppressed. Therefore, deterioration of the battery 7 is suppressed, and a decrease in the life of the battery 7 is suppressed.

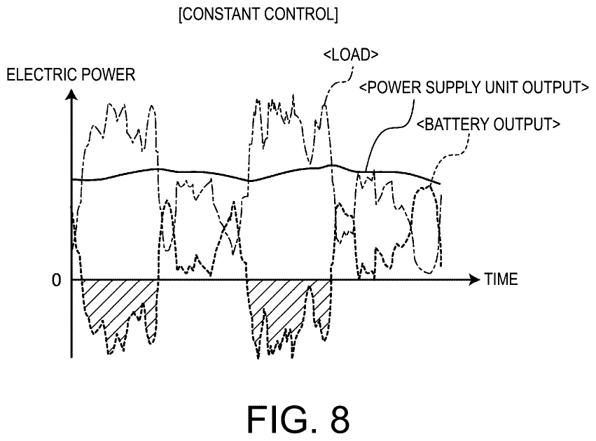

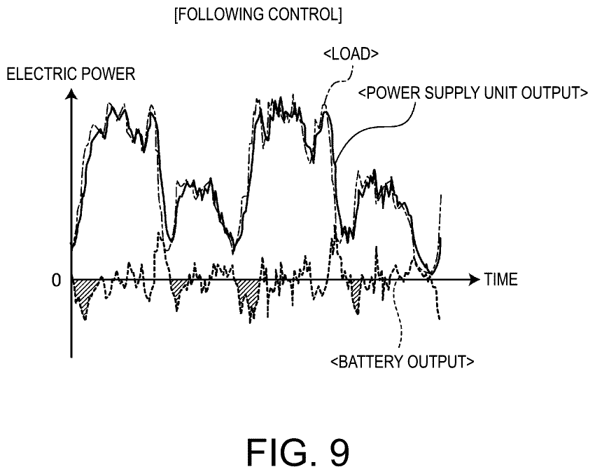

FIG. 8 is a diagram illustrating power output from a power supply unit and power output from a battery with respect to electric power usage of a load according to a comparative example. FIG. 9 is a diagram illustrating the power output from the power supply unit 6 and the power output from the battery 7 with respect to the electric power usage of the load according to the embodiment. In each of FIGS. 8 and 9, the horizontal axis represents the time during which the work machine is driven, and the vertical axis represents the electric power. <LOAD> indicates electric power usage of the load, <POWER SUPPLY UNIT OUTPUT> indicates power output from the power supply unit, and <BATTERY OUTPUT> indicates output power output from the battery.

FIG. 8 shows a case where the power output from the power supply unit 6 is constant. As illustrated in FIG. 8, the electric power usage of the load varies greatly based on, for example, the work content of the work machine 1. When the power output from the power supply unit 6 is constant, the power output from the battery 7 varies greatly in accordance with the variation in the electric power usage of the load. That is, the charge/discharge amount of the battery 7 increases. In this case, the battery 7 is likely to deteriorate.

FIG. 9 shows a case where the power output from the power supply unit 6 varies to follow the electric power usage of the load. As illustrated in FIG. 9, since the power output from the power supply unit 6 varies to follow the electric power usage of the load, the power output from the battery 7 is small. That is, the charge/discharge amount of the battery 7 is suppressed. Therefore, deterioration of the battery 7 is suppressed, and a decrease in the life of the battery 7 is suppressed.

In the embodiment, the controller 20 controls the power supply unit 6 so that the electric power supplied from the external power supply 8 to the electric motor 12 varies based on the electric power output from the power supply unit 6 to the inverter 11 and the electric power output from the battery 7 to the inverter 11. In the embodiment, the power supply unit output current and the battery current are monitored, and the load current indicating the current used by the load is calculated based on the power supply unit output current and the battery current.

In the embodiment, the controller 20 takes into account not only the electric power usage of the electric motor 12 but also the electric power usage of the plurality of loads including the high-voltage auxiliary device 15 and the low-voltage auxiliary device 17. The controller 20 varies the power output from the power supply unit 6 to follow the total electric power usage of the plurality of loads. This suppresses the variation in the charge/discharge amount of the battery 7.

When the battery 7 is charged during the operation of the work machine 1, the controller 20 controls the power supply unit 6 so that the charging rate of the battery 7 does not exceed a specified value (battery SOC target value) smaller than 100%. This suppresses deterioration of the battery 7.

### OTHER EMBODIMENTS

In the above-described embodiment, a part or all of the hydraulic actuators 5 may be replaced with electric actuators. The revolving motor 5E may be an electric motor. The traveling motor 5D may be an electric motor. Each of the boom cylinder 5A, the arm cylinder 5B, and the bucket cylinder 5C may be an electric cylinder. When all of the hydraulic actuators 5 are replaced with electric actuators, the hydraulic pump 13 and the main valve 14 are omitted.

In the above-described embodiment, the work machine 1 is an electric shovel. The work machine 1 may be, for example, an electric forklift.

### REFERENCE SIGNS LIST

1 Work machine, 2 Lower traveling body, 3 Upper revolving body, 4 Work implement, 4A Boom, 4B Arm, 4C Bucket, 5 Hydraulic actuator, 5A Boom cylinder, 5B Arm cylinder, 5C Bucket cylinder, 5D Traveling motor, 5E Revolving motor, 6 Power supply unit, 7 Battery, 8 External power supply, 9 Cable, 10 Power supply port, 11 Inverter, 12 Electric motor, 13 Hydraulic pump, 14 Main valve, 15 High-voltage auxiliary device, 16 DC/DC converter, 17 Low-voltage auxiliary device, 20 Controller, 21 First calculation unit, 22 Second calculation unit, 23 Third calculation unit, 24 Fourth calculation unit, 25 Fifth calculation unit, 26 Sixth calculation unit, 27 Seventh calculation unit, 1000 Computer system, 1001 Processor, 1002 Main memory, 1003 Storage, 1004 Interface

1. A work machine comprising:
a power supply device connected to an external power supply;
a battery charged by the power supply device;
an electric motor configured to be driven based on at least one of electric power supplied from the external power supply and electric power supplied from the battery; and
a controller configured to vary the electric power supplied from the external power supply to the electric motor to follow electric power usage of the electric motor.

2. The work machine according to claim 1 comprising an inverter to which electric power is supplied from each of the power supply device and the battery, wherein
the controller is configured to output a control command to the power supply device so that the electric power supplied from the external power supply to the electric motor varies based on the electric power output from the power supply device and the electric power output from the battery.

3. The work machine according to claim 2 comprising an auxiliary device configured to be driven based on at least one of the electric power supplied from the external power supply and the electric power supplied from the battery, wherein
the controller is configured to vary the electric power output from the power supply device to follow a total electric power usage of a plurality of loads including the electric motor and the auxiliary device.

4. The work machine according to claim 1, wherein
the controller is configured to output a control command to the power supply device so that a charging rate of the battery does not exceed a specified value smaller than 100%.

5. A control method for a work machine comprising
a power supply device connected to an external power supply,
a battery charged by the power supply device, and
an electric motor, the control method comprising:
driving the electric motor by using both electric power supplied from the external power supply and electric power supplied from the battery; and
varying the electric power supplied from the external power supply to the electric motor to follow electric power usage of the electric motor.
